(19) United States
(12) Patent Application Publication
(10) Pub. No.: US 2009/0092453 A1
(43) Pub. Date: Apr. 9, 2009

(54) INSERTS FOR PARTING OR GROOVING AND METHOD OF MAKING

(75) Inventor: Anders JONSSON, Gavle (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB, Sandviken (SE)

(21) Appl. No.: 12/245,323

(22) Filed: Oct. 3, 2008

(30) Foreign Application Priority Data
Oct. 5, 2007 (SE) 0702232-0

(51) Int. Cl. B26D 1/00

(52) U.S. Cl. 407/108; 407/118

(57) ABSTRACT

The present invention relates to a coated cutting tool insert with elongated shape with a rake face and an opposite bottom surface with improved strength properties obtained by providing the inserts with a blasted bottom surface. The inserts are preferably used for parting and grooving operations.

### CROSS-REFERENCE TO PRIOR APPLICATION

This application claims priority to Sweden Application No. 0702232-0 filed Oct. 5, 2007, which is incorporated by reference herein.

### BACKGROUND OF THE INVENTION

The present invention relates to cutting tool inserts particularly for parting or grooving with improved properties and a method of making the same.

Inserts for parting and grooving have an elongated shape. They can have a cutting edge in only one end, as shown in FIG. 1, or in both ends, as shown in FIG. 2. They are single sided with a rake face with chip breakers to ensure effective chip removal particularly in parting operations where the space is often restricted. The bottom surface generally has a shape to ensure good stability of the insert in the holder. Generally, the bottom surface is slightly concave to ensure that the inserts essentially are in contact with the insert seat of the holder at its both ends.

Inserts for parting and grooving generally have a length of more than about 15 mm and up to about 35 mm, a width of from about 1 to about 12 mm and a height of from about 5 to about 10 mm. They are generally provided with coatings deposited by CVD, MTCVD or PVD as known in the art.

U.S. Pat. No. 5,477,754 discloses a metal cutting insert made by sintering an insert body and coating the sintered insert body with a conventional coating. Subsequently, a supporting surface of the insert is ground smooth while removing the coating therefrom. The supporting surface of the insert is thereby formed by an uncoated, smoothly ground surface.

EP 1864731 A1 discloses an indexable insert wherein the residual stress in a coating on the rake face is lower than the residual stress in the bearing surface.

EP 1862240 A1 discloses an indexable insert wherein the coating on a seating face is removed completely or originally not formed thereon.

A problem with elongated inserts is that they sometimes fracture at an early stage or even already when fastened in the holder.

### OBJECTS AND SUMMARY OF THE INVENTION

It is an object of the present invention to provide inserts particularly for parting and grooving with improved strength.

It is further object of the present invention to provide a method of making inserts particularly for parting and grooving with improved strength.

In one aspect of the invention, there is provided a cutting tool insert with an elongated shape with a rake face and an opposite bottom surface, both with a coating, wherein the insert has a length, L, width, W, and height, H, all in mm, such that L>W+H and that the bottom surface of the insert is blasted.

In another aspect of the invention, there is provided a method of making a cutting tool insert having an elongated shape with a rake face and an opposite bottom surface, both with a coating, comprising providing a coated insert and blasting the bottom surface, the insert has a length, L, width, W, and height, H, all in mm, such that L>W+H.

### BRIEF DESCRIPTION OF THE DRAWINGS

FIG. 1 shows a parting and grooving insert with one cutting edge where

L—length,

H—height and

W—width.

FIG. 2 shows a parting and grooving insert with two cutting edges.

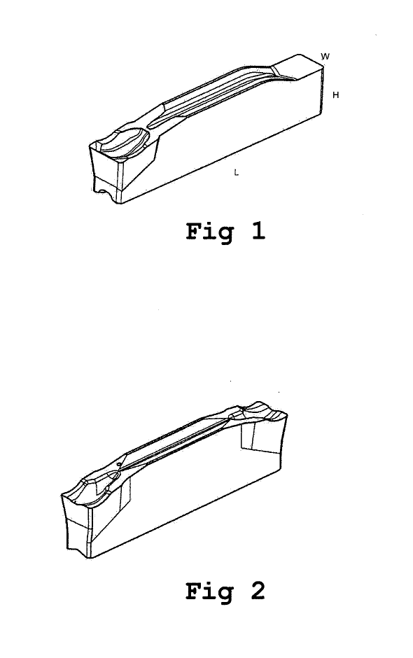

### DETAILED DESCRIPTION OF THE PREFERRED EMBODIMENTS

According to the present invention, it has now surprisingly been found that if inserts particularly for parting and grooving are subjected to a blasting operation on the bottom surface a surprising increase in strength is obtained.

The present invention relates to a cutting tool insert with an elongated shape with a rake face and an opposite bottom surface, both with a coating, the insert has a length, L, width, W, and height, H, all in mm, such that L>W+H and the bottom surface of the insert is blasted. The cutting tool insert is particularly suitable for parting and grooving. The room temperature hardness of the cutting tool insert is suitably greater than about 1500 HV3. Preferably L is greater than about 0.1*W*H*H. The length L is measured along the bottom surface, W and H in the middle of the insert. Both the rake face and the blasted bottom surface have a coating.

For a residual stress P in a coating, where P greater than 0 represents a tensile residual stress and P less than 0 represents a compressive residual stress, the coating of the bottom surface has suitably a residual stress P(b) being less than the residual stress in the coating on the rake face P(r). Preferably, the residual stress in the coating of the bottom surface is compressive, i.e., P(b)<0.

The bottom side of the insert suitably has a concave shape so that the gap occurring between the bottom surface and a flat surface on which the inserts rests, measured at the middle of the insert, is greater than about 0.01 mm, but less than about 0.1 mm, preferably less than about 0.05 mm.

The insert is preferably provided with a CVD and/or an MTCVD coating. The total thickness of the coating on non-blasted coated areas is suitably greater than about 4 μm, preferably greater than about 8 μm.

The rake face can also be blasted for improved performance.

In one embodiment, the blasted bottom surface preferably has a remaining coating with a total thickness of preferably greater than about 1 μm, most preferably greater than about 3 μm.

The invention also relates to a method of making a cutting tool insert with a coating and having an elongated shape with a rake face and an opposite bottom surface, wherein the bottom surface is blasted and the insert has a length, L, width, W, and height, H, all in mm, such that L>W+H. Preferably L greater than about 0.1*W*H*H. The length L is measured along the bottom surface, W and H in the middle of the insert.

Preferably, the insert is provided with a CVD and/or an MTCVD coating of a metal oxide, nitride, boride, carbide, carbonitride, carboxynitride or combinations thereof, the metal being Al, Ti, Cr. Si, Ta, V, Hf and/or Zr as is known in the art. The total thickness of the coating on non-blasted coated areas is suitably greater than about 4 μm, preferably greater than about 8 μm.

According to the method of the present invention, the bottom surface of the inserts are after the coating subjected to a blasting operation, preferably wet blasting. In one embodiment, the rake face is also subjected to a blasting operation. Preferably, the blasting is made with a slurry comprising Al₂O₃ in water but any other conventional blasting media ca be used.

In one embodiment, the blasting operation is made with a slurry comprising F150 grits (FEPA-standard) of Al₂O₃ in water at an air pressure of from about 2.2 to about 2.6 bar for about from about 10 to about 20 sec/insert. The spray guns are placed about 100 mm from the inserts with a 90° spray angle.

The coating of the bottom surface preferably remains to a significant extent after the blasting operation, so that the total coating thickness after the blasting operation is preferably greater than about 1 μm, most preferably greater than about 3 μm.

The insert is particularly suitable for parting and grooving.

The invention is additionally illustrated in connection with the following examples, which are to be considered as illustrative of the present invention. It should be understood, however, that the invention is not limited to the specific details of the examples.

### EXAMPLE 1

Ten inserts of type N123H2-0400-0004 TF with a composition 6 wt-% Co and rest WC with an average grain size of about 2 μm and a hardness at room temperature of 1600 HV3 to be used for parting operations with a length of 25 mm, a width of 3 mm and a thickness of 6 mm were provided with a coating of 5 μm MTCVD-Ti(C,N)+4 μm Al₂O₃. All ten inserts were blasted on the rake face. Five of them were further subjected to the same blasting operation on the bottom surface.

The wet blasting operation was performed with a slurry of F150 grits (FEPA-standard) of Al₂O₃ in water at an air pressure of 2.4 bar for about 15 sec/insert. The spray guns were placed about 100 mm from the inserts with a 90° spray angle.

The inserts were then subjected to a conventional transverse rupture test. The distance between the supports was 20 mm. The force in N necessary to break the inserts was determined. The following results were obtained:

| Treatment | Force to fracture in N | | | | | Average, N |
|---|---|---|---|---|---|---|
| Blasted | 8681 | 10000 | 9630 | 9253 | 10230 | 9559 |
| Unblasted | 7721 | 7271 | 7711 | 7766 | 7055 | 7505 |

### EXAMPLE 2

Example 1 was repeated with 10 inserts N123J2-0600-RO with a composition of 6 wt-% Co and rest WC with an average grain size of about 1 μm and a hardness at room temperature of 1750 HV3 with a length of 25 mm, a width of 4 mm and a thickness of 6 mm and a coating consisting of 2.5 μm MTCVD-Ti(C,N)+1.5 μm Al₂O₃ +0.5 μm TiN.

The inserts were subjected to a conventional transverse rupture test. The distance between the supports was 17 mm. The force in N necessary to break the inserts was determined. The following results were obtained:

| | | |
|---|---|---|
| Treatment | Force to fracture in N | Average, N |

| | | | | | | |
|---|---|---|---|---|---|---|
| Blasted | 5232 | 4373 | 6452 | 6250 | 4284 | 5318 |
| Unblasted | 4946 | 3923 | 5835 | 5100 | 3480 | 4657 |

It is concluded that the present invention gives an increase in fracture strength.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Cutting tool insert with an elongated shape with a rake face and an opposite bottom surface, both with a coating, wherein the insert has a length, L, width, W, and height, H, all in mm, such that L>W+H and that the bottom surface of the insert is blasted.

2. Cutting tool insert according to claim 1, wherein L is greater than about 0.1*W*H*H.

3. Cutting tool insert according to claim 1, wherein the insert is provided with a CVD and/or MTCVD coating.

4. Cutting tool insert according to claim 1, wherein the coating on non-blasted coated areas is greater than about 4 μm thick.

5. Cutting tool insert according to claim 1, wherein the residual stress in the coating of the bottom surface is less than the residual stress in the coating on the rake face.

6. Cutting tool insert according to claim 1, wherein the bottom side of the insert has a concave shape so that the gap occurring between the bottom surface and a flat surface on which the inserts rests, measured at the middle of the insert, is greater than about 0.01 mm.

7. Cutting tool insert according to claim 1, wherein the blasted bottom surface has a remaining coating with a total thickness of greater than about 3 μm.

8. Cutting tool insert according to claim 1, wherein the insert is an insert for parting and grooving operations.

9. Cutting tool insert according to claim 1, wherein the rake face is blasted.

10. Method of making a cutting tool insert having an elongated shape with a rake face and an opposite bottom surface, both with a coating, comprising providing a coated insert and blasting the bottom surface, the insert has a length, L, width, W, and height, H, all in mm, such that L>W+H.

11. method according to claim 10, wherein L is greater than about 0.1*W*H*H.

12. Method according to claim 10, wherein the insert is provided with a CVD and/or an MTCVD coating.

13. Method according to claim 10, wherein the insert has a coating of a total thickness of greater than about 4 μm on non-blasted coated areas.

14. Method according to claim 10, wherein the bottom side of the insert has a concave shape so that the gap occurring between the bottom surface and a flat surface on which the inserts rests, measured at the middle of the insert, is greater than about 0.01 mm.

15. Method according to claim 10, wherein the blasted bottom surface has a remaining coating with a total thickness of greater than about 3 μm.

16. Method according to claim 10, wherein the rake face is subjected to a blasting operation.

17. Method according to claim 10, wherein the insert is an insert for parting and grooving operations.
